(19) United States
(12) Patent Application Publication
(10) Pub. No.: US 2012/0169397 A1
(43) Pub. Date: Jul. 5, 2012

(54) Mixed Signal Integrator Incorporating Extended Integration Duration

(76) Inventors: Oren E. Eliezer, Plano, TX (US); Sidharth Balasubramanian, Columbus, OH (US)

(21) Appl. No.: 13/291,708

(22) Filed: Nov. 8, 2011

Related U.S. Application Data
(60) Provisional application No. 61/428,504, filed on Dec. 30, 2010.

(51) Int. Cl. G06G 7/18

(52) U.S. Cl. 327/336

(57) ABSTRACT

A mixed-signal integrator, having an analog input and a digital output, is adapted to perform an integration operation partially in the analog domain and partially in the digital domain while eliminating the limitations of a conventional analog integrator. The integrator also digitizes a signal of interest without the use of a conventional sampling operation followed by a conventional analog-to-digital converter. The analog integrator portion generates an analog integration signal limited between low and high rail voltages defined by two comparators with corresponding threshold voltages. When either rail voltage is reached, the polarity of the input signal is reversed to prevent the integration result from exceeding that rail. Each such event is also tracked in digital logic, which provides a count whenever two consecutive such events correspond to the two different rails. At the end of the integration duration this count serves as the digital representation of the integration result.

### REFERENCE TO PRIORITY APPLICATION

This application claims priority to U.S. Provisional Application Ser. No. 61/428,504, filed Dec. 30, 2010, entitled “Mixed-Signal Integrator For Ultra-Narrow Bandwidths,” incorporated herein by reference in its entirety.

### FIELD OF THE INVENTION

The present invention relates to the field of signal processing, and more particularly relates to an integrator with an extended integration duration constructed using both analog and digital circuitry.

### BACKGROUND OF THE INVENTION

An electronic integrator is a commonly used function that is constructed to perform integration of signals with respect to time. The integration operation can be viewed as a first-order low-pass filter, having a pole at f=0 Hz (i.e. DC), which can be accurately performed in the analog domain (i.e. in the continuous-time domain) or may be approximated in the digital domain (i.e. discrete-time domain). An integrator will have a low-pass filtering effect for signals at frequencies above zero Hz (i.e. DC), but it's theoretical response to a constant DC at its input is a ramp having a consistent trend, which, in practice, will continue only until it reaches a limit of the system, at which time a saturation or overflow type of behavior is to be expected.

A current integrator is an electronic circuit performing a time integration of a current signal, thus producing an electric charge. This is typically realized using a capacitor, which also serves to convert the integration result from charge into a linearly proportional voltage, according to Equations 1 and 2 below, where i(t), in units of Amperes, represents the current signal being integrated, Q₀ represents the initial charge in the capacitor at t=0, Q(t=T) represents the charge accumulated in the capacitor up to time t=T seconds, C represents the capacitance of the capacitor in Farads, and V_{c}(t) represents the voltage signal on the capacitor, in units of Volts, that is a result of the charge accumulated in it:

$$\begin{matrix}Q ( t = T ) = {Q}_{0} + {\int }_{0}^{T} i ( t ) d t & ( 1 ) \\ {V}_{C} ( t ) = \frac{1}{C} Q ( t ) & ( 2 )\end{matrix}$$

A voltage integrator is an electronic circuit that performs a time integration of a voltage signal. It is typically realized through the conversion of that voltage into a linearly proportional current and applying that current to a current integrator, where the physical entity being accumulated is typically electric charge. As shown above in Equation 2, the voltage on a capacitor is linearly proportional to the charge accumulated in it with the proportion factor being 1/C, where C is the value of its capacitance. While this implies that this conversion factor may be increased arbitrarily by reducing C, it is impractical to allow this capacitance to reach values that approach those of the inevitable parasitics that surround it. At the other end, it is impractical to realize very large capacitors that would allow for extended integration duration, in an integrated circuit, with cost being proportional to silicon area.

### SUMMARY OF THE INVENTION

The present invention provides a novel and useful structure for a mixed-signal integrator adapted to perform an integration operation partially in the analog domain and partially in the digital domain while eliminating the limitations of a conventional analog only integrator. A substantial amount of the functionality of the integrator is shifted into the digital domain to take advantage of the ever decreasing cost and increasing performance of semiconductor processes.

An analog integrator generates an analog integration signal between low and high rail voltages. A ‘rail flip’ occurs when either rail voltage is reached, at which instance the circuit's controller reverses the polarity of the input signal. A digital count is maintained which tracks the occurrences of the rail flipping and provides a digital representation of the integration result.

Several advantages of the mixed-signal integrator of the present invention include: (1) performing an integration function providing a digitized result without the need for conventional analog to digital converters; (2) providing an analog to digital function without the need for sampling and anti-aliasing filtering; (3) providing an extended-duration integration and analog to digital conversion function without the need for large time constants to be realized in the analog domain; (4) providing an integration and analog to digital conversion function requiring relatively small capacitance values which can be easily incorporated in an integrated circuit; and (5) providing an integration function having a relatively large integration time window that is bounded by the width of a digital accumulator rather than by any analog circuit component values.

There is thus provided in accordance with the invention, a mixed signal integrator, comprising an analog integrator operative to integrate an input signal and generate an analog integrator output therefrom, a detection circuit operative to detect said analog integrator output reaching an upper threshold and a lower threshold and to generate a polarity toggle signal based thereon, a crossover switch operative to reverse the polarity of the signal input to said analog integrator in accordance with said polarity toggle signal, and a digital accumulator circuit operative to generate a digital integrator result as a function of said upper and lower threshold detections.

There is also provided in accordance with the invention, a mixed-signal integrator, comprising a crossover switch operative to receive an input signal and to reverse the polarity thereof in accordance with a polarity toggle, an analog integrator operative to integrate the output of said crossover switch and to generate an analog integrator output therefrom, a comparator circuit operative to generate a digital overflow indication when said analog integrator signal reaches a high rail voltage, and to generate a digital underflow indication when said analog integrator signal reaches a low rail voltage, a mapping circuit operative to generate accumulator increment and decrement commands in accordance with said overflow and underflow rail signals and said polarity toggle state, and a digital accumulator operative to accumulate a digital integrator result in accordance with said increment and decrement commands.

There is further provided in accordance with the invention, a method of mixed-signal integration, said method comprising, integrating in the analog domain an input signal to generate an analog integrated output therefrom, reversing the polarity of a signal input to said integrating step upon said analog integrated output reaching either an upper or lower threshold, and accumulating in the digital domain a digital integrator result as a function of reaching said upper and lower thresholds.

There is also provided in accordance with the invention, a method of mixed-signal integration, said method comprising integrating in the analog domain an input signal to generate an analog integrated output therefrom, generating a digital overflow signal upon said analog integrated output reaching a high rail voltage, and generating a digital underflow signal upon said analog integrated output reaching a low rail voltage, reversing the polarity of the signal input to said integrating step upon said analog integrated output reaching either said high rail voltage or said low rail voltage, and accumulating in the digital domain a digital integrated result as a function of said digital overflow and underflow signals.

There is further provided in accordance with the invention, a method of mixed-signal integration, said method comprising performing a first partial integration of an input signal in the analog domain whereby a partial integrator output is generated from said input signal, and performing a second partial integration of said input signal in the digital domain wherein an integrator output is generated from said partial integrator output.

There is also provided in accordance with the invention, a method of mixed-signal integration, said method comprising integrating in the analog domain an input voltage between a low rail voltage and a high rail voltage to generate an analog integrated output therefrom, updating a digital count and reversing the polarity of said input voltage in response to said analog integrated output reaching either said low rail voltage or said high rail voltage, wherein said digital count is representative of the number of times the analog integration result moved from said low rail to said high rail over time, such that a movement in the opposite direction would be counted negatively, and reading the value of said digital count after a time period of interest to provide a digital integration result therefrom.

There is further provided in accordance with the invention, a method of mixed-signal integration, said method comprising integrating in the analog domain an input voltage between a low rail voltage and a high rail voltage to generate an analog integrated output therefrom, updating a digital count and reversing the polarity of said input voltage in response to said analog integrated output reaching either said low rail voltage or said high rail voltage, wherein said digital count is representative of the number of ΔV=V_{H}−V_{L} movements that occur over time, wherein V_{H} and V_{L} represent said high rail and low rail voltages respectively, and reading the value of said digital count after a duration of interest to provide a result corresponding to the integral of the input waveform up to that instance, being effectively converted into a digital measurement.

### BRIEF DESCRIPTION OF THE DRAWINGS

The invention is herein described, by way of example only, with reference to the accompanying drawings, wherein:

FIG. 1 is a block diagram illustrating an example mixed-signal integrator constructed in accordance with the present invention;

FIG. 2 is a block diagram illustrating a crossover switch of the present invention;

FIG. 3 is a block diagram illustrating a first example embodiment of the accumulator logic circuitry of the present invention;

FIG. 4 is a block diagram illustrating a second example embodiment of the accumulator logic circuitry of the present invention;

FIGS. 5A, 5B and 5C are a flow diagram illustrating an example mixed-signal integration method; and

FIG. 6 is a diagram illustrating an example waveform at the output of the analog stage of the mixed-signal integrator.

### DETAILED DESCRIPTION OF THE INVENTION

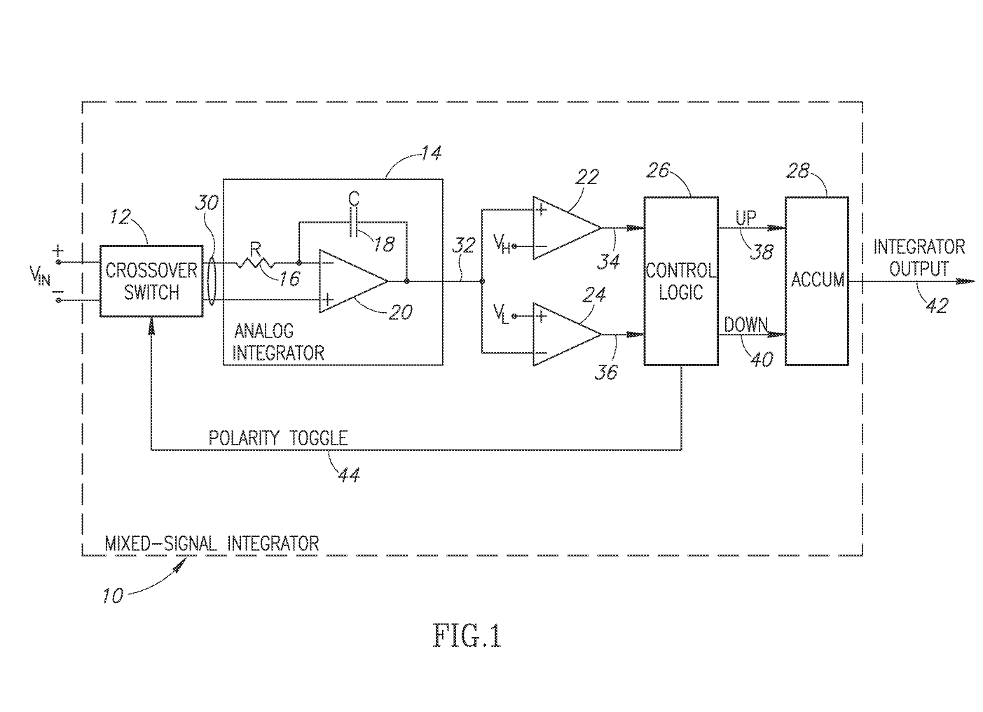

A block diagram illustrating an example mixed-signal integrator constructed in accordance with the present invention is shown in FIG. 1. The mixed-signal integrator, generally referenced 10, comprises a crossover switch 12, analog integrator 14, comparators 22, 24, control logic circuit 26 and accumulator 28.

In general, the mixed-signal integrator is adapted to perform an integration operation partially in the analog domain and partially in the digital domain while eliminating the limitations of a conventional analog only integrator. The invention attempts to push a substantial amount of the functionality of the integrator into the digital domain to take advantage of the ever decreasing cost and increasing performance of semiconductor processes such as CMOS.

In general, the input signal (which may comprise a differential or single ended signal) is input to a crossover switch 12. The crossover switch is operative to either provide a straight through (i.e. non-inverted) or reversed (i.e. inverted) path for the input signal. The polarity of the output of the crossover switch is determined by a polarity toggle signal 44.

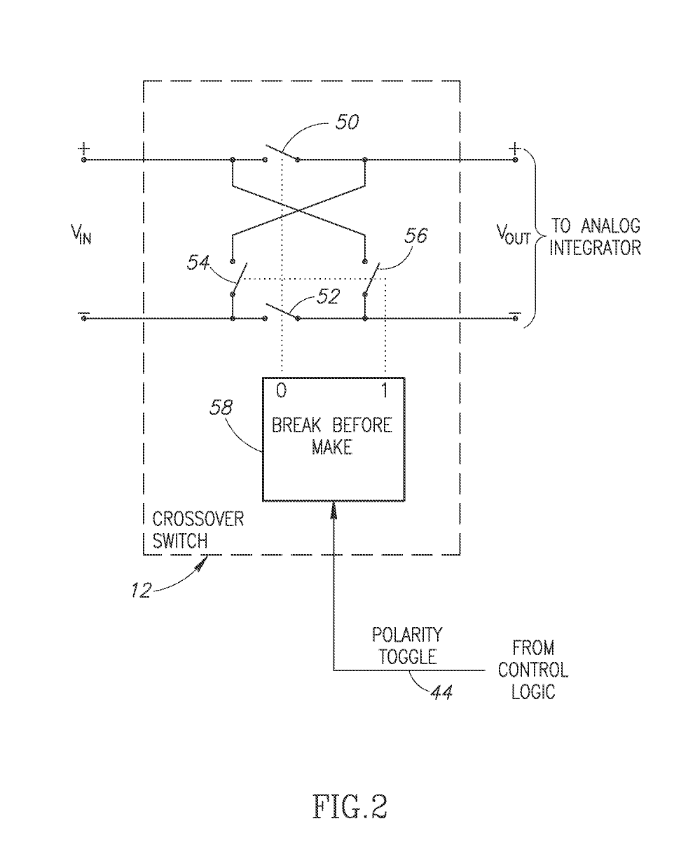

A block diagram illustrating a crossover switch of the present invention is shown in FIG. 2. The example crossover switch, generally referenced 12, comprises switches 50, 52, 54, 56 arranged and configured to transmit the differential input voltage either (1) straight through to the analog integrator, or (2) inverted, where the ‘+’ and ‘−’ terminals are reversed. Whether to pass the input signal straight through or with reversed polarity is determined by the polarity toggle signal 44 from the control logic circuit 26. Preferably a ‘break before make’ circuit 58 is used to ensure the + and − inputs do not experience a momentary short circuit.

In an example embodiment, the crossover switch is realized using a transmission-gate topology. Such a structure is commonly used as an analog CMOS switch and exhibits a relatively low ‘on’ resistance and high ‘off’ resistance (i.e. isolation) while avoiding a threshold voltage drop across the switch.

The straight or inverted differential output of the crossover switch is input to an analog integrator 14. The analog integrator comprises a resistor R 16 in combination with capacitor C 18 and operational amplifier (op amp) 20. The op amp is configured as a conventional analog integrator having an RC time constant determined by the values of R and C.

The analog integrated output of the analog integrator is then input to a pair of comparators 22 and 24. Comparator 22 functions to compare the analog integrated output signal to an upper threshold V_{H} which represents the upper limit of the analog integrator output. The value of V_{H} is typically an upper (i.e., high) rail voltage. In the positive direction, when the analog integrated output signal reaches (exceeds) the threshold voltage V_{H}, a high rail signal 34 is generated and input to the control logic circuit 26.

Similarly, comparator 24 functions to compare the analog integrated output signal to a lower threshold V_{L} which represents the lower limit of the analog integrator output. The value of V_{L} is typically a lower (i.e., low) rail voltage. In the negative direction, when the analog integrated output signal reaches (exceeds) the threshold voltage V_{L}, a low rail signal 36 is generated and input to the control logic circuit 26.

Thus, the comparators serve as the transition point between the analog and digital domains without performing sampling. Before the comparators, the integrator 14 performs an integration function in the analog domain. All processing subsequent to the comparator stage is performed in the digital domain. The comparators produce digital signals 38 and 40 that are used in the digital domain to count each event wherein the instantaneous analog integration result has reached a point that is ΔV distant from that of the previous event, where ΔV=V_{H}−V_{L}. If, for example, the integration result has reached V_{H}, the next counted event would occur when the result reaches V_{L}. In this example, the integration result would have ‘traveled’ a ‘distance’ of negative ΔV. The correct digital operation to account for this, however, would be a decrement operation only if the polarity-toggle signal indicates that the input signal's polarity has not been reversed. Otherwise, the control logic circuit 26 accounts for this negative ΔV change by generating an increment operation for the accumulator 28.

In general, the control logic functions to interpret the high and low rail signals 34, 36 and to generate UP (i.e., increment) 38 and DOWN (i.e., decrement) 40 commands to the accumulator 28, in addition to generating the polarity toggle signal input to the crossover switch 12. The toggling (or switching) of the polarity of the crossover switch is referred to as a ‘rail flip’. The control logic is operative to “flip” or toggle the polarity of the input to the analog integrator whenever the analog integrated output signal reaches either the upper (high) or lower (low) rails, while the significance of such an event, as accounted for by the digital accumulator, depends on both a current and a previous rail hit. Thus, while rail flips occur based on the current rail hit, the digital accumulation of rail-flipping events depends on rail hit history as well (i.e., a count is generated only when consecutive rail hit or ‘rail-flip’ events are from the two different rails).

The UP and DOWN command outputs of the control logic circuit are input to the accumulator 28. The function of the accumulator 28 is to generate (accumulate) the digital integrator result 42 based on the UP 38 and DOWN 40 signals received from the control logic.

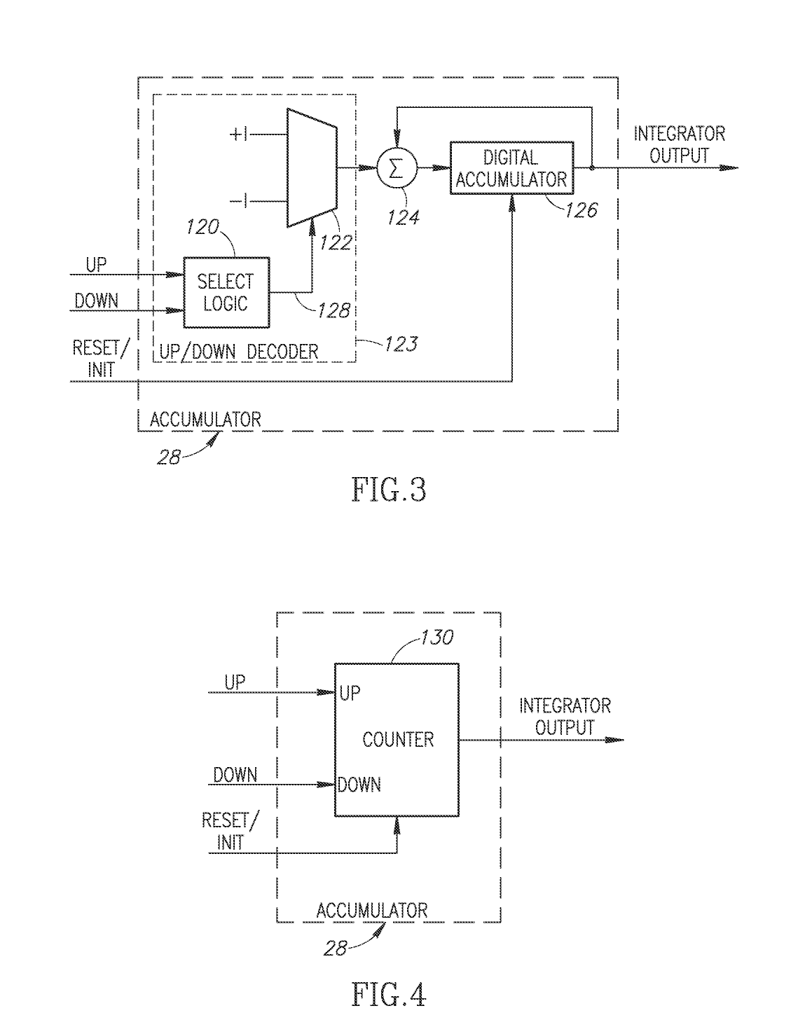

A block diagram illustrating a first example embodiment of the accumulator of the present invention is shown in FIG. 3. In this first example embodiment, the accumulator, generally referenced 28, comprises a select logic circuit 120, a two input multiplexer 122, an adder 124 and a digital accumulator 126. In operation, the UP and DOWN commands are decoded by the select logic circuit 120 to generate the select input to the multiplexer. The inputs to the multiplexer comprise fixed values +1 and −1. Thus, upon receiving an UP command, the select command is generated to add a ‘+1’ to the current value of the accumulator via adder 124. Similarly, upon receiving a DOWN command, the select command is generated to add a ‘−1’ to the current value of the accumulator via adder 124. At any time, the contents of the digital accumulator represent the digital integration result accumulated thus far. The accumulator can be reset upon initialization or a reset operation via the RESET/INIT input signal.

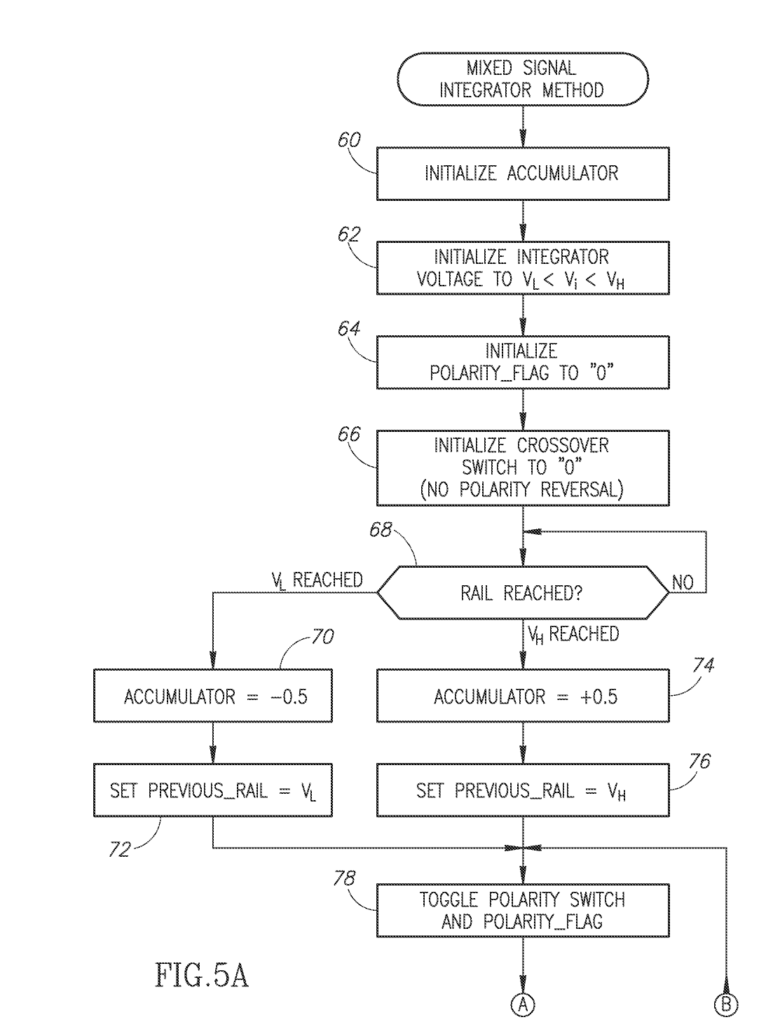

A block diagram illustrating a second example embodiment of the accumulator of the present invention is shown in FIG. 4. In this second example embodiment, the accumulator, generally referenced 28, comprises an up/down counter 130 operative to receive the UP and DOWN commands from the control logic circuit. The UP and DOWN commands may interface directly (or via a logic circuit) to the counter. Receiving an UP command causes the counter to increment its current value and receiving a DOWN command causes the counter to decrement its current value.

Note that in the accumulator embodiments shown in FIGS. 3 and 4, an increment value of +1 and decrement value of −1 are shown. It is appreciated that the invention is not limited to the use of increments and decrements of one, as any value may be used depending on the particular implementation of the invention. For example, depending on the initial value of the analog integrator voltage and the thresholds set for the upper and lower rails, increment/decrement values other than one may be desired. Further, the value used for incrementing may be different than that used for decrementing.

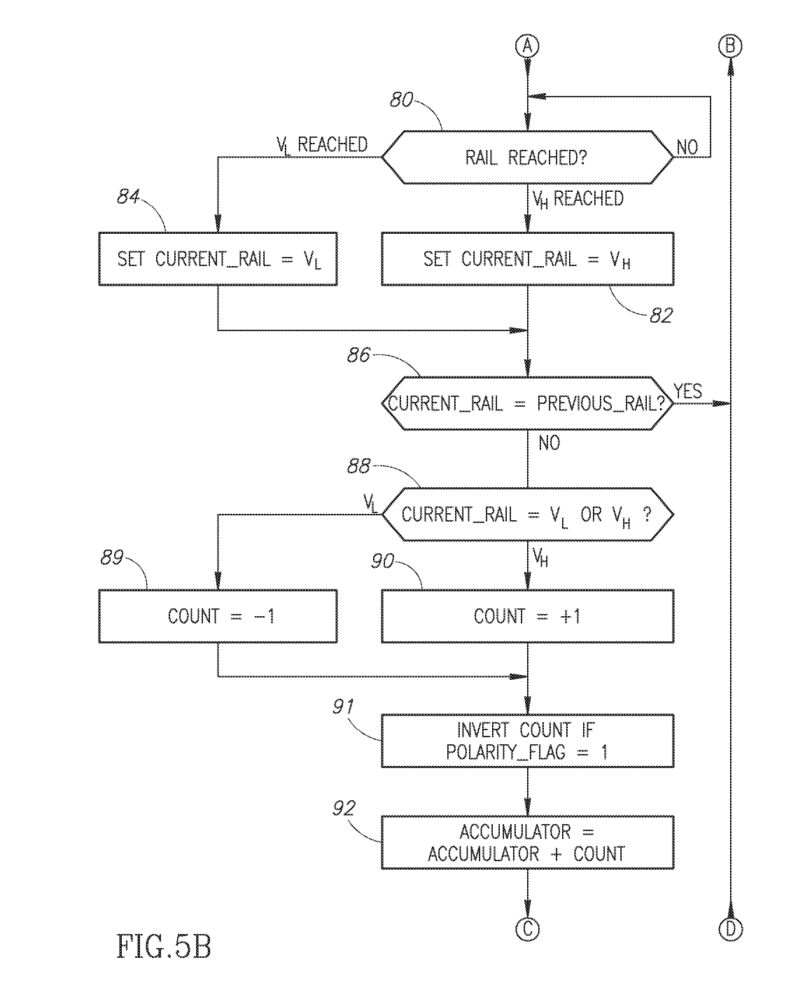

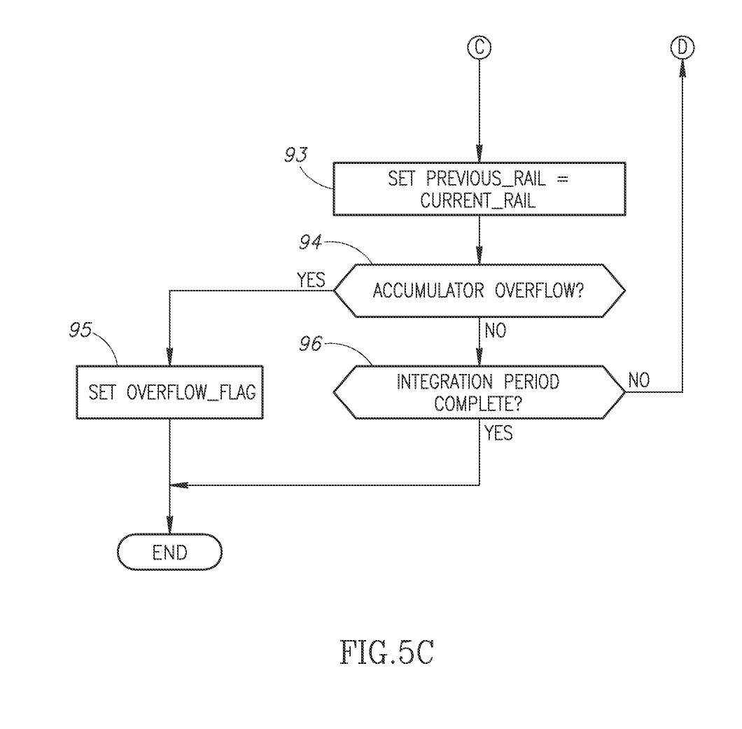

A flow diagram illustrating an example mixed signal integration method is shown in FIGS. 5A, 5B and 5C. First, the accumulator is initialized (step 60). The analog integrator voltage is initialized to a value V_{L}<Vᵢ<V_{H} (step 62). In one embodiment, the analog integrator voltage is initialized to V_{M}=½(V_{L}+V_{H}). The polarity_flag binary flag, used to indicate the polarity state of the crossover switch (either straight or reversed), is initialized to ‘0’ (i.e. straight) (step 64). The crossover switch is initialized to ‘0’ (i.e. no polarity reversal) (step 66).

Once initialized, the analog integrator begins integration of the input voltage. The analog integrated output of the integrator is monitored by the comparators 22, 24 (FIG. 1). If either the upper or lower rail is reached (step 68), the subsequent steps depend on whether the upper rail V_{H} or the lower rail V_{L} was reached. If the upper rail V_{H} was reached, the accumulator is set to +0.5, which corresponds to the selection of V_{M} as the initial voltage in the analog integrator (step 74) and the value of previous_rail is set to indicate V_{H} (step 76). Conversely, if the lower rail V_{L} was reached, the accumulator is set to −0.5 (step 70) and the value of previous_rail is set to indicate V_{L} (step 72). Thus, the first rail hit determines the sign of the end integration result.

Whenever one of the rails is reached, the polarity of the crossover switch 12 (FIG. 1) must be toggled (step 78). In addition, polarity flag, which is used to indicate the state of the crossover switch, is toggled as well (i.e., either to 0 or 1). Analog integration continues until another rail is reached (step 80). Once a rail is reached, subsequent steps depend on whether the upper rail V_{H} or the lower rail V_{L} was reached. If the upper rail V_{H} was reached, the current_rail register is set to indicate the upper rail V_{H} was reached (step 82). If the lower rail V_{L} was reached, current_rail is set to indicate the lower rail V_{L} was reached (step 84).

If the value of current_rail equals previous_rail (step 86), this means that the analog integrator output left the rail but reversed direction to hit the same rail previously hit. This indicates a change in the sign of the integration occurring in the analog integration either from positive to negative or negative to positive. In this case, the rail hit is not accumulated and does not affect the digital integration result. The method continues at step 78.

On the other hand, if current_rail is not equal to previous_rail (step 80), this indicates that the analog integrator actually traveled the full width ΔV of the rails, i.e. ΔV=V_{H}−V_{L}. In this case, the accumulator is modified to take into account the rail hit. In particular, the accumulator is decremented or incremented in accordance with the direction of movement (i.e. from V_{L} to V_{H} or vice versa) and the state of the polarity toggle flag (i.e. polarity_flag indicating the state of the crossover switch).

It is first checked if the current_rail is set to V_{L} or V_{H} (step 88). If current_rail is set to V_{L}, count is set to −1 (step 89). If current_rail is set to V_{H}, count is set to +1 (step 90). If the polarity_flag, =1, the value of count is inverted (step 91). The count is then added to the accumulator (step 92).

The value of previous_rail is set to current_rail (step 93). If the accumulator has not overflowed (step 94) or has not been initialized (which would be done after the reading of its last result), the method continues with step 78. If the accumulator has overflowed, the operation stops and an overflow_flag is set (step 95), to provide such an indication once the result is read. When the integration period is over (step 96) the result in the accumulator, which may be positive or negative, provides a digital representation of the integration of the analog input voltage over the period of the integration.

Thus, during the integration process, ‘overflow’ and ‘underflow’ signals are created by the two comparators 22, 24 (FIG. 1) and are mapped into carry and borrow pulses that increment or decrement the digital integration result in the accumulator accordingly. The significance of an ‘overflow’/‘underflow’ event depends on historical rail hit events. For example, for a positive DC input signal, and in the absence of noise, the integration result will be a constantly rising ramp, such that the V_{H} threshold is reached first. The ‘overflow’ indication that is produced as a result of that should create a ‘carry’ or ‘increment’ command for the digital accumulator.

Once the V_{H} threshold is reached, the polarity of the input is reversed, which results in the analog integrator producing a negative slope until the V_{L} threshold is reached. Then, the ‘underflow’ indication produced by the V_{L} comparator also produces a ‘carry’ or ‘increment’ command, since the input remained positive and the V_{L} limit was only reached because of the polarity reversal.

Conversely, if the input signal were negative to begin with, and the analog integration reached the V_{L} threshold first, then the ‘underflow’ indication from that comparator should result in a ‘borrow’ or ‘decrement’ command for the digital accumulator, eventually leading to a negative count in the accumulator.

In general, the significance of an ‘overflow’ or ‘underflow’ event depends on the state of the polarity reversal switch for the input, which is toggled in response to each V_{H}/V_{L} threshold crossing.

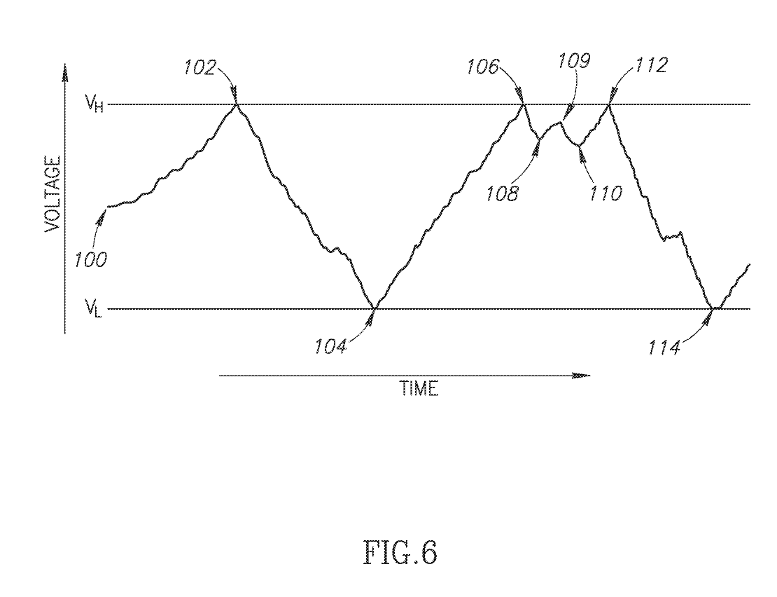

A diagram illustrating an example of the operation of the mixed-signal integrator is shown in FIG. 6. In this example, the input V_{IN} to the crossover switch is assumed to be DC in addition to noise. Absent noise, a positive DC voltage should produce a triangle wave pattern at the output of the analog integrator. At each rail hit, the accumulator would be incremented by one (assuming an increment/decrement value of one).

With the introduction of noise, however, the uniform triangle wave becomes choppy. With the integrator output being initialized to V_{L}+½ΔV (referenced 100), the integrator is shown to begin integration in the positive direction The analog integrator output continues to rise until the upper rail V_{H} is hit (referenced 102) at which time, the value of previous_rail is set to V_{H} and the polarity of the crossover switch is toggled. Now, the input to the analog integrator is reversed and the voltage decreases in response to the positive DC input voltage. At some point, the lower rail V_{L} is reached (referenced 104) and since previous_rail is set to V_{H}, in addition to a polarity reversal being performed for the input signal (polarity toggle), an UP command is generated such that the accumulator is incremented and previous_rail is set to V_{L}. Since the input to the analog integrator has been reversed again, the integrator's voltage increases again in response to the positive DC input voltage (up to the point referenced 106).

Once the upper rail V_{H} is reached again (referenced 106) a polarity reversal is performed (polarity toggle), and since previous_rail is set to V_{L}, another UP command is generated and the accumulator is incremented and previous_rail is set to V_{H}. The input to the analog integrator is reversed again and the voltage decreases in response to the positive DC input voltage. At the point referenced 108, the direction of the integration reverses due to noise and rises until point 109 at which instant it reverses again and decreases to point 110. At point 110, the direction of the integration reverses again, due to variations in the input signal or noise, and rises to reach the upper rail V_{H} (referenced 112). A polarity reversal is performed (polarity toggle) but an UP/DOWN command is not generated and the accumulator is neither incremented nor decremented since previous_rail=current_rail=V_{H}. The value of previous_rail remains set to V_{H}.

Due to the polarity toggle at point 112, the analog integration continues in a downward direction towards the lower rail. Upon reaching the lower rail (referenced 114), a polarity reversal is performed (polarity toggle), and since previous_rail is set to V_{H}, an UP command is generated and the accumulator is incremented and previous_rail is set to V_{L}.

In an alternative embodiment, the mixed-signal integrator can be used in an instrument to digitally measure very low voltages. This is achieved by converting the low voltage into a digital count that is read after an arbitrarily long time duration. This effectively converts a voltage resolution problem into a time/digital resolution problem, which is significantly easier to accommodate at high precision.

The integration time-constant RC and the low and high rail voltages in the analog integrator are configured to appropriate values so as to guarantee a large number of rail flips within the integration period. The mixed-signal integrator can be calibrated a priori whereby the digital count (integrator output) generated for known input voltages and time duration are recorded. When an unknown input voltage is applied, the resulting digital count over the same time period is used to look up a corresponding voltage. Interpolation, rounding or other known approximation techniques can be used to determine the input voltage.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A mixed signal integrator, comprising:
an analog integrator operative to integrate an input signal and generate an analog integrator output therefrom;
a detection circuit operative to detect said analog integrator output reaching an upper threshold and a lower threshold and to generate a polarity toggle signal based thereon;
a crossover switch operative to reverse the polarity of the signal input to said analog integrator in accordance with said polarity toggle signal; and
a digital accumulator circuit operative to generate a digital integrator result as a function of said upper and lower threshold detections.

2. The integrator according to claim 1, wherein said input signal comprises a differential input signal.

3. The integrator according to claim 1, wherein said detection circuit comprises a first comparator configured to detect said analog integrator output reaching said upper threshold.

4. The integrator according to claim 1, wherein said detection circuit comprises a second comparator configured to detect said analog integrator output reaching said lower threshold.

5. The integrator according to claim 1, wherein said detection circuit is operative to generate said polarity toggle in the event said analog integrator output reaches either said upper threshold or said lower threshold.

6. The integrator according to claim 1, wherein said crossover switch is operative to reverse the polarity of said input signal input to said analog integrator utilizing a break before make circuit.

7. The integrator according to claim 1, wherein said upper threshold comprises a high rail voltage and said lower threshold comprises a low rail voltage.

8. The integrator according to claim 1, wherein said accumulator circuit is operative to increment said digital integrator result when said analog integrator reaches said upper threshold and a previous threshold reached was said lower threshold while the input signal crossover switch is not set to invert the polarity of the input signal, and said accumulator circuit operative to decrement said digital integrator if the crossover switch was set to invert the polarity of the input signal.

9. The integrator according to claim 1, wherein said accumulator circuit is operative to decrement said digital integrator result when said analog integrator reaches said lower threshold and a previous threshold reached was said upper threshold while the input signal crossover switch is not set to invert the polarity of the input signal, and said accumulator circuit operative to increment said digital integrator if the crossover switch was set to invert the polarity of the input signal.

10. A mixed-signal integrator, comprising:
a crossover switch operative to receive an input signal and to reverse the polarity thereof in accordance with a polarity toggle;
an analog integrator operative to integrate the output of said crossover switch and to generate an analog integrator output therefrom;
a comparator circuit operative to generate a digital overflow indication when said analog integrator signal reaches a high rail voltage, and to generate a digital underflow indication when said analog integrator signal reaches a low rail voltage;
a mapping circuit operative to generate accumulator increment and decrement commands in accordance with said overflow and underflow rail signals and said polarity toggle state; and
a digital accumulator operative to accumulate a digital integrator result in accordance with said increment and decrement commands.

11. The integrator according to claim 10, wherein said input signal comprises a differential input signal.

12. The integrator according to claim 10, wherein said comparator circuit comprises a first comparator configured to generate said overflow signal when said analog integrator output reaches said high rail voltage.

13. The integrator according to claim 10, wherein said comparator circuit comprises a second comparator configured to generate said underflow signal when said analog integrator output reaches said low rail voltage.

14. The integrator according to claim 10, wherein said mapping circuit is operative to generate said polarity toggle in the event said analog integrator output reaches either said high rail voltage or said low rail voltage.

15. The integrator according to claim 10, wherein said crossover switch is operative to reverse the polarity of said input signal input to said analog integrator utilizing a break before make circuit.

16. The integrator according to claim 10, wherein said mapping circuit is operative to generate said increment command when said analog integrator reaches said high rail and the previous rail reached was said low rail while the input signal crossover switch is not set to invert the polarity of the input signal, said mapping circuit operative to generate said decrement command if the crossover switch was set to invert the polarity of the input signal.

17. The integrator according to claim 10, wherein said mapping circuit is operative to generate said decrement command when said analog integrator reaches said low rail and the previous rail reached was said high rail while the input signal crossover switch is not set to invert the polarity of the input signal, said mapping circuit operative to generate said increment command if the crossover switch was set to invert the polarity of the input signal.

18. A method of mixed-signal integration, said method comprising:
integrating in the analog domain an input signal to generate an analog integrated output therefrom;
reversing the polarity of a signal input to said integrating step upon said analog integrated output reaching either an upper or lower threshold; and
accumulating in the digital domain a digital integrator result as a function of reaching said upper and lower thresholds.

19. The method according to claim 18, wherein said input signal comprises a differential input signal.

20. The method according to claim 18, wherein said upper threshold comprises a high rail voltage and said lower threshold comprises a low rail voltage.

21. The method according to claim 18, wherein said digital integrator is incremented when said analog integrated output reaches said upper threshold and a previous threshold reached was said lower threshold while an input signal crossover switch is not set to invert the polarity of the input signal, and wherein said digital integrator is decremented if the crossover switch was set to invert the polarity of the input signal.

22. The method according to claim 18, wherein said digital integrator is decremented when said analog integrated output reaches said lower threshold and a previous threshold reached was said upper threshold while an input signal crossover switch is not set to invert the polarity of the input signal, and wherein said digital integrator is incremented if the crossover switch was set to invert the polarity of the input signal.

23. A method of mixed-signal integration, said method comprising:
integrating in the analog domain an input signal to generate an analog integrated output therefrom;
generating a digital overflow signal upon said analog integrated output reaching a high rail voltage, and generating a digital underflow signal upon said analog integrated output reaching a low rail voltage;
reversing the polarity of the signal input to said integrating step upon said analog integrated output reaching either said high rail voltage or said low rail voltage; and
accumulating in the digital domain a digital integrated result as a function of said digital overflow and underflow signals.

24. The method according to claim 23, wherein said input signal comprises a differential input signal.

25. The method according to claim 23, wherein said digital integrated result is incremented upon generation of an overflow signal and a previous rail reached was said low rail while an input signal crossover switch is not set to invert the polarity of the input signal, and wherein said digital integrated result is decremented if the crossover switch was set to invert the polarity of the input signal.

26. The method according to claim 23, wherein said digital integrated result is decremented upon generation of an underflow signal and a previous rail reached was said high rail while an input signal crossover switch is not set to invert the polarity of the input signal, and wherein said digital integrated result is incremented if the crossover switch was set to invert the polarity of the input signal.

27. A method of mixed-signal integration, said method comprising:
performing a first partial integration of an input signal in the analog domain whereby a partial integrator output is generated from said input signal; and
performing a second partial integration of said input signal in the digital domain wherein an integrator output is generated from said partial integrator output.

28. The method according to claim 27, further comprising:
comparing said partial integrator output to a high rail threshold and a low rail threshold; and
reversing the polarity of said input signal in the event said partial integrator output reaches either said high rail threshold or said low rail threshold.

29. The method according to claim 27, wherein performing said second partial integration comprises accumulating in the digital domain said integrator output as a function of high rail threshold and low rail threshold crossings of said partial integrator output.

30. A method of mixed-signal integration, said method comprising:
integrating in the analog domain an input voltage between a low rail voltage and a high rail voltage to generate an analog integrated output therefrom;
updating a digital count and reversing the polarity of said input voltage in response to said analog integrated output reaching either said low rail voltage or said high rail voltage, wherein said digital count is representative of the number of times the analog integration result moved from said low rail to said high rail over time, such that a movement in the opposite direction would be counted negatively; and
reading the value of said digital count after a time period of interest to provide a digital integration result therefrom.

31. The method according to claim 30, wherein said input voltage comprises a differential input voltage.

32. The method according to claim 30, wherein said digital count is incremented when said analog integrated output reaches said high rail voltage and a previous rail reached was said low rail voltage while an input signal crossover switch is not set to invert the polarity of the input signal, and wherein said digital count is decremented if the crossover switch was set to invert the polarity of the input signal.

33. The method according to claim 30, wherein said digital count is decremented when said analog integrated output reaches said low rail voltage and the previous rail reached was said high rail voltage while an input signal crossover switch is not set to invert the polarity of the input signal, and wherein said digital count is incremented if the crossover switch was set to invert the polarity of the input signal.

34. A method of mixed-signal integration, said method comprising:
integrating in the analog domain an input voltage between a low rail voltage and a high rail voltage to generate an analog integrated output therefrom;
updating a digital count and reversing the polarity of said input voltage in response to said analog integrated output reaching either said low rail voltage or said high rail voltage, wherein said digital count is representative of the number of ΔV=V_{H}−V_{L} movements that occur over time, wherein V_{H} and V_{L} represent said high rail and low rail voltages respectively; and
reading the value of said digital count after a duration of interest to provide a result corresponding to the integral of the input waveform up to that instance, being effectively converted into a digital measurement.

35. The method according to claim 34, wherein said input voltage comprises a differential input voltage.

36. The method according to claim 34, wherein said digital count is incremented when said analog integrated output reaches said high rail voltage and a previous rail reached was said low rail voltage while an input signal crossover switch is not set to invert the polarity of the input signal, and wherein said digital count is decremented if the crossover switch was set to invert the polarity of the input signal.

37. The method according to claim 34, wherein said digital count is decremented when said analog integrated output reaches said low rail voltage and a previous rail reached was said high rail voltage while an input signal crossover switch is not set to invert the polarity of the input signal, and wherein said digital count is incremented if the crossover switch was set to invert the polarity of the input signal.
